(19) United States
(12) Patent Application Publication
(10) Pub. No.: US 2006/0251792 A1
(43) Pub. Date: Nov. 9, 2006

(54) Rice flour composition with enhanced process tolerance and solution stability

(76) Inventors: Roxanna Shariff, Somerville, NJ (US); Wolfgang Bindzus, Hassbergen (DE); Yong-Cheng Shi, Manhattan, KS (US); Tarak Shah, Raritan, NJ (US); Vincent R. Green, Easton, PA (US)

Correspondence Address: NATIONAL STARCH AND CHEMICAL COMPANY, P.O. BOX 6500, BRIDGEWATER, NJ, 08807-3300, US

(21) Appl. No.: 11/401,004

(22) Filed: Apr. 10, 2006

Related U.S. Application Data
(60) Provisional application No. 60/676,585, filed on Apr. 29, 2005.
(60) Provisional application No. 60/692,833, filed on Jun. 22, 2005.

(51) Int. Cl. A21D 2/00

(52) U.S. Cl. 426/622

(57) ABSTRACT

The present invention relates to a rice flour composition with enhanced process tolerance and solution stability, the method of making such flour, and uses thereof. The flour is prepared by heat-moisture treatment of a low amylose rice flour. The resultant flour is useful in a variety of industrial applications, particularly in foods.

This application claims priority to U.S. Provisional Application No. 60/676,585 filed 29 Apr. 2005 and 60/692,833 filed 22 Jun. 2005.

### BACKGROUND OF THE INVENTION

The present invention relates to a rice flour composition with enhanced process tolerance and solution stability, the method of making such rice flour, and uses thereof. The rice flour is prepared by heat-moisture treatment of a low amylose rice flour.

Flour is typically composed of starch, protein, lipids, fiber and other materials. Starch, typically the primary component of flour, is a complex carbohydrate composed of two types of polysaccharide molecules, amylose, a mostly linear and flexible polymer of D-anhydroglucose units that are linked by alpha-1,4-D-glucosidic bonds, and amylopectin, a branched polymer of linear chains that are linked by alpha-1,6-D-glucosidic bonds.

Native flours or starches are often inadequate to meet the demanding needs of the food industry in processed foods. Starches are often chemically modified by numerous techniques known in the industry to change the functionality of the starch and meet these needs. In particular, chemical modifications are often made to increase process tolerance and stability in an aqueous dispersion or high moisture food.

When an aqueous dispersion of native starch is heated, the starch granules begin to swell, and the dispersion develops a cohesive, salve-like texture. During the process of cooking native starches, this textural state rapidly changes to an elastic, rubbery state in which the swollen granules rupture. Minor variations in cooking time, temperature, and concentration as well as shear and pH are sufficient to effect this transformation. Certain types of chemical modification may be used to overcome the extreme sensitivity of the swollen starch granules to handling and processing conditions.

In recent years there has been a trend toward developing starches which have all the properties of a modified starch, but with much lower levels of, or even no, chemical treatment. For example, attempts have been made to increase the low temperature stability of starches by using beta-amylase to enzymatically hydrolyze cross-linked waxy starches (Wurzburg, U.S. Pat. No. 3,525,672). Such hydrolysis shortens or removes the outermost beta-chains of the starch molecule. Thus, the possibility of association on the part of these branches is lessened, resulting in significant reduction of syneresis and gelling of the food products during exposure to low or freezing temperatures.

Compared to the option to use a wide variety of established modified starches in order to meet the often sophisticated needs of food processing as well as consumer demands, the food industry has limited options to use flours which display a high level of functionality, including in processed high moisture foods. When used in high moisture foods, native flours are known to show variability in viscosity and other undesirable attributes under food processing conditions. Further, just like native starch, native flour has the tendency to contribute to undesirable long and cohesive textures and has poor stability in processed high moisture foods.

Known technical solutions to improve the functionality of flours in high moisture foods include hybrid selection and physical processing. For example, waxy flour can be used to improve the stability of processed foods. However, such a food does not have a high level of process tolerance and tends to develop an inferior, cohesive, gelled texture.

Heat-moisture treatment of flours is known in the art to enhance the process tolerance of flours containing amylose through the process of annealing. However, such flours display poor stability when used in high moisture foods.

Surprisingly, it has now been discovered that heat-moisture treatment of a low amylose rice flour results in flour which has unique and useful properties, specifically enhanced process tolerance and solution stability.

### SUMMARY OF THE INVENTION

The present invention relates to a rice flour composition with enhanced process tolerance and solution stability, the method of making such rice flour, and uses thereof. The rice flour is prepared by heat-moisture treatment of a low amylose rice flour. This invention further relates to food products which contain the rice flour, particularly processed foods with high moisture levels.

Flour, as used herein, is intended to mean, a multicomponent composition which includes starch and may include protein, fat (lipids), fiber, vitamins and/or minerals. Flour is intended to include, without limitation, meal, wholemeal, cone, grits, and flaking grits, but is not intended to include pure starch.

Low amylose, as used herein, is intended to mean an amylose content lower than 18-25% (common rice flour), but higher than about 3% (common waxy rice flour), amylose based upon the weight of the starch in the flour.

Process tolerance, as used herein, is intended to mean that the flour, when exposed to heat, shear and/or acidic conditions during processing in a high moisture environment, such as in a high moisture food, will have a short, non-cohesive texture and a viscosity significantly higher than that of the native flour.

Solution stability, as used herein, is intended to mean that the flour remains stable and does not gel in a high water (moisture) environment. Specifically, using a flour in which the starch has been fully cooked out (gelatinized) in an aqueous solution at 9% solids and a pH of 3, a spoonful may be taken out of the solution and a divot will not form or will fill back in again within five minutes, such that the solution levels out again.

Gelatinization, as used herein, is intended to mean the process by which starch is cooked out and loses its granular structure. Granular is intended to mean the structure of native starch in which the starch is not water soluble, at least partially crystalline, and may have birefringence and a Maltese cross under polarized light.

Protein denaturation, as used herein, is intended to describe a noncovalent change in the protein structure. Such change may alter the secondary, tertiary or quaternary structure of the protein polymer.

Target temperature, as used herein, is intended to mean the substantially constant temperature (after ramp up time) of the flour at which it is processed.

### BRIEF DESCRIPTION OF THE FIGURES

FIG. 1 depicts modulus (G′) data of various heat-moisture treated amylose containing flours cooked by Rheology Method B2 (see Examples for details).

FIG. 2 depicts Brabender viscosity of native and heat-moisture treated waxy and low amylose rice flours under neutral conditions (pH=6.5).

FIG. 3 depicts the texture ballot used in evaluating samples in the Examples section.

### DETAILED DESCRIPTION OF THE INVENTION

The present invention relates to a rice flour composition with enhanced process tolerance and solution stability, the method of making such rice flour, and uses thereof. The rice flour is prepared by heat-moisture treatment of a low amylose rice flour.

The rice flour used in preparing the present invention is derived from native sources. Native, as used herein, is one as it is found in nature. Also suitable are flours derived from a plant obtained by standard breeding techniques including crossbreeding, translocation, inversion, transformation or any other method of gene or chromosome engineering to include variations thereof. In addition, starch derived from a plant grown from induced mutations and variations of the above generic composition which may be produced by known standard methods of mutation breeding are also suitable herein.

The rice flour suitable in the present invention has a starch component with a low amylose content. In one embodiment, the flour is a rice flour and has between 5 and 15%, and in another embodiment between 10 and 13% amylose content, and in yet another embodiment 13-15%, by weight of the starch in the flour.

The flour may be derived from the plant material by any method used in the art of manufacturing flour, and in one embodiment is derived by dry milling. However, other methods, including combinations of wet and dry milling techniques may be used.

In one embodiment, the flour will contain about 8-25% moisture, 1-50% protein, 0.1-8% fat (lipids), 1-50% fiber, 20-90% starch, 0-3% ash and optionally, other components such as nutrients (e.g. vitamins and minerals). The particle size may be varied as may the percents of the components using methods known in the art. For example, fine grinding and air classification may be used to alter the protein content. Flour is intended to include, without limitation, white flour, wholemeal flour, wholegrain flour, and grits.

In preparing the rice flour of this invention it is necessary that the starting flour have a specified amount of water or moisture content and is heated to a defined temperature in order to accomplish the goal of enhanced process tolerance and solution stability. The total moisture or water content of the starch to be heat treated will be in the range of from about 10 to 80%, and in one embodiment will be in the range of 15 to 30%, by weight of the dry flour. In another suitable embodiment, the level of moisture is substantially maintained during the heating step. This may be accomplished, for example, by heat treating the flour in a sealed vessel to avoid water evaporation. In another embodiment, the heat treatment has a drying effect and reduces the moisture content of the flour during processing.

The flour with specified moisture content is heated to a target temperature of from about 50 to 180° C., and in one aspect from about 80 to 120° C. It is important that the starch of the flour remain in the granular state. Other changes may occur, including denaturation of the protein. The time of heating can vary depending on the composition of the flour, including the starch and protein content, the particle size distribution, the amylose content of the starch component, and the level of enhancement of the process tolerance desired as well as the amount of moisture and the heating temperature. In one embodiment, the heating time at target temperature will be from about 1 to 150 minutes, and in another embodiment from about 30 to 120 minutes.

The heat treatment may be conducted using any equipment known in the art which provides sufficient capabilities for powder processing, moisture addition and moisture control, mixing, heating and drying. The heat treatment may be done as a batch or a continuous process. In one embodiment, the equipment is a batch ploughshare mixer. In another embodiment, the equipment is a continuous solid-liquid mixer followed by a continuous heated conveyer screw. In yet another embodiment, the continuous process uses a tubular thin film dryer by itself or in combination with a continuous screw to extend and control the residence time. Any system used may be pressurized to control the moisture content at target temperatures at or above 100° C.

The conditions for treating the flour must be such that the granular structure of the starch within the flour is not destroyed. In one embodiment, the granules are still birefringent and there is evidence of a maltese cross when the granular structure of the starch is viewed under polarized light. Under some conditions, such as at high moisture and high temperature, the starch granule may be partially swollen but the crystallinity is not completely destroyed. However, this should be minimized in order to maintain the highest possible process tolerance. Accordingly, the term “granular starch” as used herein, means a starch which predominantly retains its granular structure and has some crystallinity, and the granules may be birefringent and the maltese cross may be evident under polar light. Further, the denaturing effect of the heat-moisture treatment on the protein component may have an impact on the observed functionality of the flour. The resulting starch product which has been heat treated will still have at least some granular structure and in one embodiment will be birefringent when viewed under the microscope and have a maltese cross when viewed under polarized light.

The rice resultant flour will have enhanced process tolerance and solution stability. The rice flour is process tolerant such that when exposed to heat, shear and/or acidic conditions during processing in a high moisture environment, such as in a high moisture food, it will have a short, non-cohesive texture and a viscosity significantly higher than that of the native flour and, if modified prior to heat-moisture treatment, higher than prior to such treatment. High moisture environment or food, as used herein, means with at least 50% water (moisture) by weight of the environment or food and would include a solution or sol of such flour. In one aspect of the invention, the viscosity of the flour after heat-moisture treatment (in water at 9% solids) will have a viscosity at least five times higher than the native flour and in another aspect, at least about eight times higher.

In one embodiment the rice flour will have an absorbance value of at least 0.1, and less than 0.3 using Absorbance Method C1. In another embodiment, the rice flour will have an absorbance value of greater than 0.1, and less than 0.2 using Absorbance Method C2.

The resultant rice flour will also have solution stability in that the rice flour remains stable and does not gel in a high water (moisture) environment. Specifically, using a flour in which the starch has been fully cooked out (gelatinized) in an aqueous solution at 9% solids and a pH of 3, a spoonful may be taken out of the solution and a divot will not form or will not fill back in again within five minutes, such that the solution levels out again.

The resultant rice flour, after its starch has been fully cooked out at 9% solids and a pH of 3, is further characterized by a modulus (G′) of greater than 25 and less than 150 Pa using Rheology Method B1. In another embodiment, the resultant flour, after its starch has been fully cooked out at 9% solids and a pH of 3, is further characterized by a modulus (G′) of greater than 250 and less than 600 Pa using Rheology Method B2.

The resultant rice flour, after its starch has been fully cooked out at 9% solids and a pH of 3, is further characterized by a tangent delta (tan δ) of greater than 0.25 and less than 1.0 using Rheology Method B1. In another embodiment, the resultant flour, after its starch has been fully cooked out at 9% solids and a pH of 3, is further characterized by a tangent delta (tan δ) of greater than 0.10 and less than 0.50 using Rheology Method B2. Generally, starches having a tangent delta of greater than 1 are known to be fluid-like or viscous while those with a tangent delta of below 1 can be either soft sets or strong gels. While soft set samples may have tangent delta between 0.1 and 0.5, more strongly gelled samples will have tangent delta less than 0.1. The modulus and tangent delta characteristics are more exactly defined as measured in the Examples section.

After the heat-moisture treatment, the flour may be allowed to air dry to reach equilibrium moisture conditions or may be dried using a flash dryer or other drying means, including spray drying, freeze-drying, or drum drying. In one embodiment, the flour is air dried or flash dried. The pH of the flour may also be adjusted and is typically adjusted to between 6.0 and 7.5.

The flour may be further modified, chemically, physically and or enzymatically to provide additional functionality or desirable properties. Such modification may be accomplished prior to and/or after heat-moisture treatment. In one embodiment the flour is not further modified and in another is modified after the heat-moisture treatment.

Chemical modifications include treatment with any reagent or combination of reagents provided the modification does not fully destroy the granular nature of the starch and is intended to include without limitation crosslinked starches, acetylated and organically esterified starches, hydroxyethylated and hydroxypropylated starches, phosphorylated and inorganically esterified starches, cationic, anionic, nonionic, and zwitterionic starches, and succinate and substituted succinate derivatives of starch. Such modifications are known in the art, for example in Modified Starches: Properties and Uses, Ed. Wurzburg, CRC Press, Inc., Florida (1986). Other suitable modifications and methods are disclosed in U.S. Pat. Nos. 4,626,288, 2,613,206 and 2,661,349. However, it should be noted that while crosslinking may enhance the process tolerance and or solution stability, the invention does not include those embodiments in which the crosslinking alone is sufficient to obtain the desired effect.

In one embodiment, the flour is not chemically modified. This has the added advantage of clean labeling.

Physical modification is intended to include shearing and other physical changes which are known in the art and may be carried out on flour. In one aspect of the invention, the particle size distribution of the flour prior to or after heat-moisture treatment is modified through methods known in the art, such as grinding and sieving, agglomeration, or granulation. In another aspect, the composition of the flour is modified though the use of fine grinding and air classification.

Enzymatic modification is intended to include modification by any enzyme so long as it can hydrolyze without destroying the granular structure of the starch within the flour and includes hydrolysis of the starch and/or of the proteins present in the flour.

The flour may also be subjected to other processes known in the art of starch or flour, such as conversion by acid and/or heat and oxidation. The flour may be purified using methods known in the art, to remove starch off flavors, odors, or colors that are native to the flour or created during processing. Alkali washing techniques are also useful and known in the art.

The resultant rice flour of this invention may be used in any food or beverage composition (hereinafter collectively referred to as foods). This includes foods for human and/or animal consumption. Typical food products include, but are not limited to, baby foods, soups, sauces, dressings, gravies, ready meals, dairy products, and other high moisture foods. Food processing may include mixing, shearing, cooking, retorting, UHP processing, freezing or other known food processing methods. Further, the flours may be suitable for other foods such as cereals such as ready-to-eat, puffed or expanded cereals and cereals which are cooked before eating; baked goods such as breads, crackers, cookies, cakes, muffins, rolls, pastries and other grain-based ingredients; pasta; beverages; fried and coated foods; snacks; meat products; condiments; and cultured dairy products such as yogurts, cheeses, and sour creams.

The amount of rice flour which can be added and used in any given food will be determined to a great extent by the amount that can be tolerated from a functional standpoint. In other words, the amount of flour used generally will be as high as will be acceptable in organoleptic evaluation of the food. In one aspect of the invention, the flour is used at about 0.1 to 50%, by weight of the food and in another from about 1 to 25% by weight. The composition will additional contain at least one other edible component. Such edible components are known in the art and include without limitation proteins, carbohydrates, fats, vitamins and minerals.

### EXAMPLES

The following examples are presented to further illustrate and explain the present invention and should not be taken as limiting in any regard. All parts and percentages are given by weight and all temperatures in degrees Celsius (° C.) unless otherwise noted.

The following ingredients were used throughout the examples.
a) Waxy Rice Flour (WRF), commercially available from Bangkok Industries (Bao Kao Den, Thailand), 1.2% amylose
b) Low Amylose Rice Flour, commercially available from Riviana Foods (Houston, Tex., USA) as RM-100AR, batch #7519, 12.8% amylose
c) Singapore Regular Rice Flour (RRF), commercially available from Bangkok Industries (Bao Kao Den, Thailand), 22.4% amylose

The following test procedures were used throughout the examples.

A. Thermal Analysis

Thermal analysis of the native and heat moisture treated flours was performed using Perkin Elmer Differential Scanning Calorimeter (DSC) 7 with liquid nitrogen cooling accessory. 10 mg of anhydrous sample was weighed into a stainless steel hermetic pan and appropriate amount of water was added to obtain 3:1 water to flour ratio. The pan was sealed and scanned from 10-160° C. at 10° C./min heating rate. The samples were run in duplicates and the average values of onset, peak and end melting temperatures (° C.) and gelatinization enthalpy values (J/g) are reported.

B. Rheology

Method B1: Cooking at 95° C. without Controlled Bath

Rheological tests were conducted on starch dispersions obtained by heating a slurry of flour (9% solids, on anhydrous basis, in a pH 3 buffer) in a water bath set to 95° C. for 20 minutes. After cooking, the mass loss due to evaporation was corrected for. Samples expected to gel were poured into molds while hot. The sample was then cooled to room temperature and tested on a rheometer. The rheometer was a Rheometrics Fluids Spectrometer III (Rheometrics Scientific, Piscataway, N.J.). All measurements were made using parallel plate geometry. An oscillatory frequency sweep was conducted on the sample over a range of 1.0 rad/sec to 100 rad/sec, with a strain in the linear-viscoelastic window of the sample. The linear viscoelastic strain, y, is defined as a strain which is small enough not to disrupt the structure of the material being tested. Resulting profiles of G′, G″ are measured and the tan delta is calculated from the ratio of G″ to G′. Elastic modulus and tangent delta values reported are at a frequency of 10 radians/second.

Method B2: Cooking at 95° C. in a Controlled Bath

Samples were bath cooked at 95° C. in a controlled bath (Lauda E100, Ecoline Star edition) so as to maintain the temperatures accurately (±0.02° C.). All flour samples were cooked at 9% solids (anhydrous) for 20 minutes in pH=3 buffer. After cooking the mass loss due to evaporation was corrected for with DI water. For materials that were expected to gel, samples were prepared in molds for rheological testing. After cooking in the boiling water bath they were poured into molds while hot. The molds consist of a metal plate of size 7.5 cm×7.5 cm and 1 mm thickness. A rubber of the same size and thickness is placed on this plate and sealed with oil. The rubber has a round hole cut out in the center and has diameter of 50 mm. Samples were used hot to dispense due to ease of use in handling. After cooling the samples were covered with mylar film and then left to sit on the bench top for ˜2 hours before testing on the rheometer. Rheological properties were measured on the samples ˜2 hours after they were cooked. All samples were tested on the Rhios RFS III rheometer from Rheometric Scientific. Parallel plate geometry of diameter 50 mm was used with a gap size of 1.5 mm. Both dynamic and steady data were collected. Samples were tested in duplicate to ensure good reproducibility. The appropriate amount of sample was loaded onto the rheometer using a plastic spatula. After setting the gap size, the sample is trimmed around the plate with a plastic spatula to remove excess material. The sample is then covered with 50 cps silicon oil to prevent drying during the test. For materials that are gelled only dynamic data is collected on the samples.

The following standard rheology sequence was used

(i) dynamic strain sweep: strain 0.1% -100%. When an appropriate strain is obtained the test is stopped. @25° C.

(ii) dynamic frequency sweep: freq. 1-100 rad/s @25° C.

(iii) transient step rate: shear rate=1.0 (1/s), zone time=120 sec. @25° C.

(iv) steady rate sweep: rate=1-100 (1/s) delay before measure=40 secs. @25° C.

C. Absorbance:

Method C1: Materials from Cook Method B1

Flour sample was cooked at 9% flour solids (anhydrous basis), in 1% NaCl solution at 95° C. without a controlled bath. The cook was then diluted to 1% flour solids and 100 gms is poured into a 100 ml graduated cylinder. The solvent for diluting was also a 1% NaCl solution. After 24 hours, the inhibited materials (sediments) and the uninhibited materials stays in the supernatant. The turbidity of the supernatant can provide a measure of the uninhibited material. This was measured as the absorbance at a wavelength of 700 nm. on a Spec 21D (Milton Roy, Rochester, N.Y.), using a cuvette with a 1 cm path length.

Method C2: Materials from Cook Method B2

Flour sample was cooked at 9% flour solids (anhydrous basis), in pH=3.0 buffer according to method B2 as described above. Samples were cooked in a controlled bath at 95° C. The cook was then diluted to 1% flour solids and 100 gms is poured into a 100 ml graduated cylinder. The solvent for diluting was also pH=3.0 buffer. After 24 hours, the inhibited materials (sediments) and the uninhibited materials stays in the supernatant. The turbidity of the supernatant can provide a measure of the uninhibited material. This was measured as the absorbance at a wavelength of 700 nm. on a Spec 21 D (Milton Roy, Rochester, N.Y.), using a cuvette with a 1 cm path length.

D. Brabender Viscosity

A Brabender viscoamylograph at neutral conditions (pH 6.5) was run to measure the viscosity profile of rice flours. 9% slurry solids (anhydrous) based on the flour solids was used. 41.4 anhydrous grams of flour was added in a tared plastic beaker with stirring rod. Buffer solution to a total weight of 83.0±1.0 grams of starch and buffer solution was added and mixed thoroughly to form a smooth paste. Then, sufficient buffer solution was added to bring the total charge weight to 460.0 grams. The slurry was mixed well with the stirring rod and added to a Brabender Viscoamylograph bowl. The following temperature profile was run to measure the viscosity with a 700 cmg sensitivity cartridge. Initial temperature was set to 50° C. and then a controlled heating of 1.5° C./min heating rate was applied to a maximum temperature of 92° C. A 15 min hold period at 92° C. was applied at the end. Brabender viscosity, measured in Brabender Units (BU) was plotted against time and temperature.

Preparation for the buffer solution: Buffer solution (pH 6.5) is used in place of distilled water and is prepared as follows:

Solution A—0.2 M Na2HPO4 prepared by dissolving 28.39 grams of anhydrous disodium phosphate (sodium phosphate, dibasic) to 1 liter with distilled or deionized water in a volumetric flask.

Solution B—0.1M Citric Acid prepared by dissolving 21.01 grams of citric acid, monohydrate to 1 liter with distilled or deionized water in a volumetric flask. Mix 710 mL of solution A with 290 mL of solution B to make the pH 6.5 buffer mixture.

E. Amylose Content by Dotentiometric Titration

0.5 g of a starch (1.0 g of a ground grain) sample was heated in 10 mls of concentrated calcium chloride (about 30% by weight) to 95° C. for 30 minutes. The sample was cooled to room temperature, diluted with 5 mls of a 2.5% uranyl acetate solution, mixed well, and centrifuged for 5 minutes at 2000 rpm. The sample was then filtered to give a clear solution.

The starch concentration was determined polarimetrically using a 1 cm polarimetric cell. An aliquot of the sample (normally 5 mls) was then directly titrated with a standardized 0.01 N iodine solution while recording the potential using a platinum electrode with a KCl reference electrode. The amount of iodine needed to reach the inflection point was measured directly as bound iodine. The amount of amylose was calculated by assuming 1.0 gram of amylose will bind with 200 miligrams of iodine. The percent error on the amylose test is ±1% in the amylose range below 20%. At higher amylose percents the error could be higher.

F. Texture Evaluations

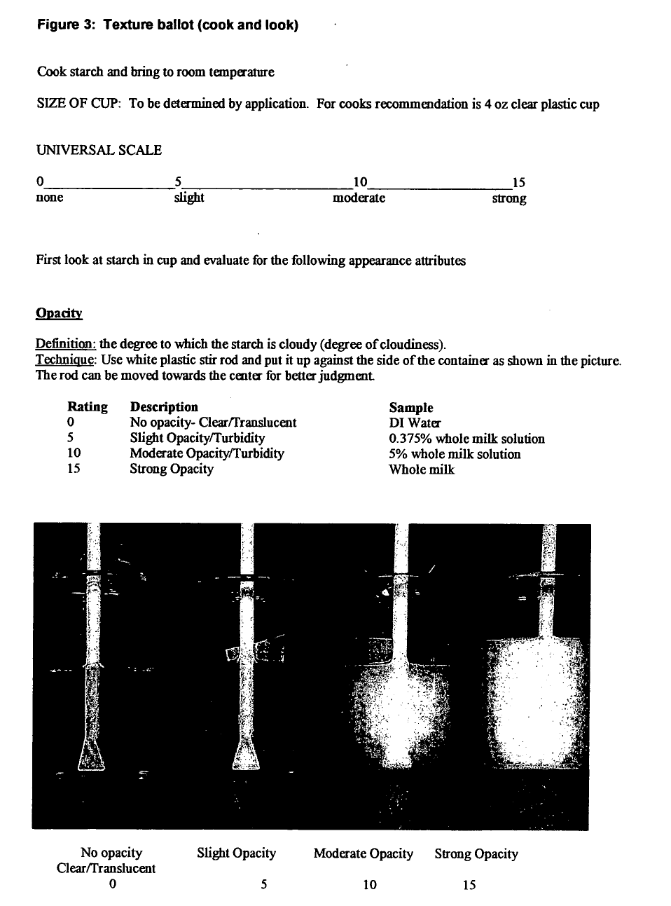

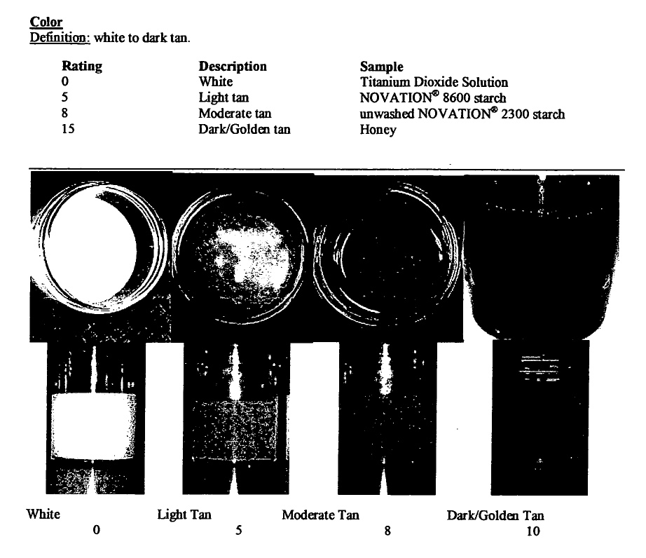

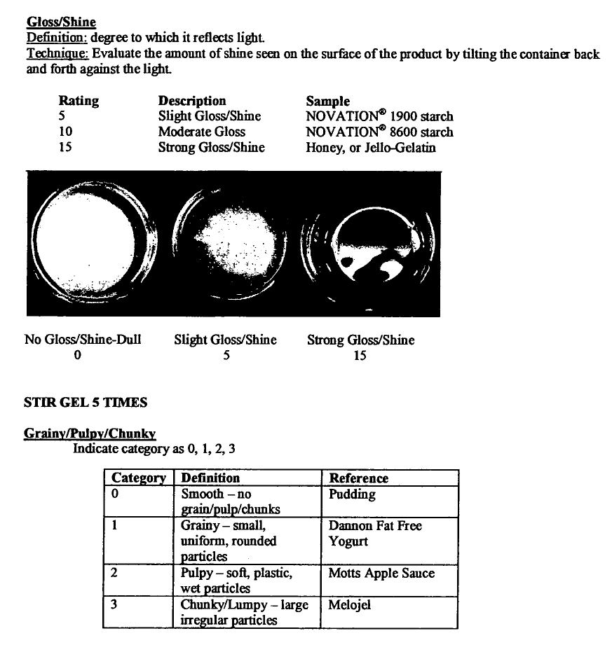

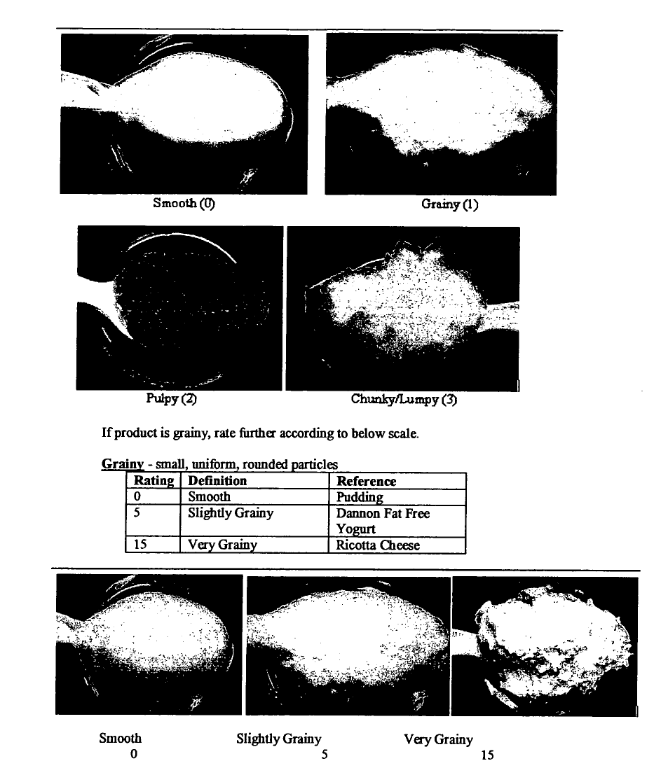

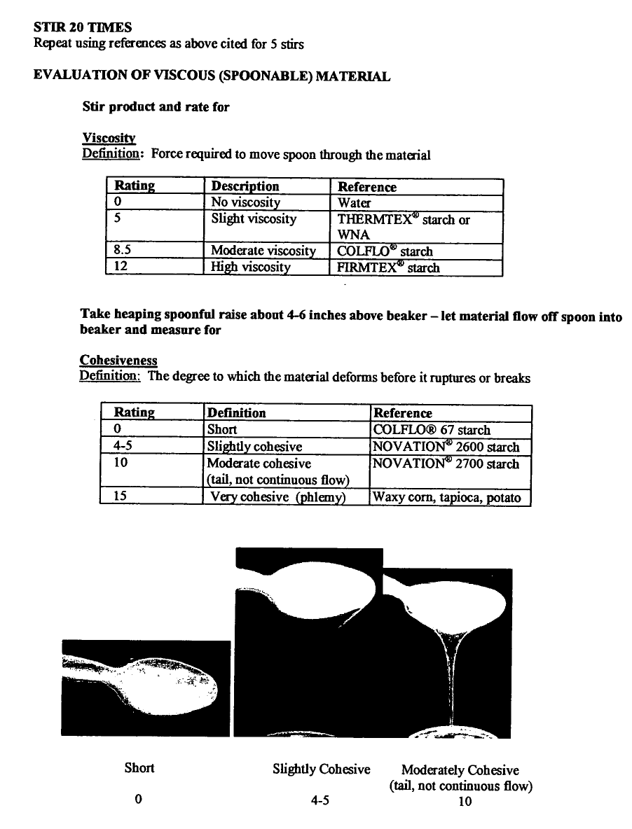

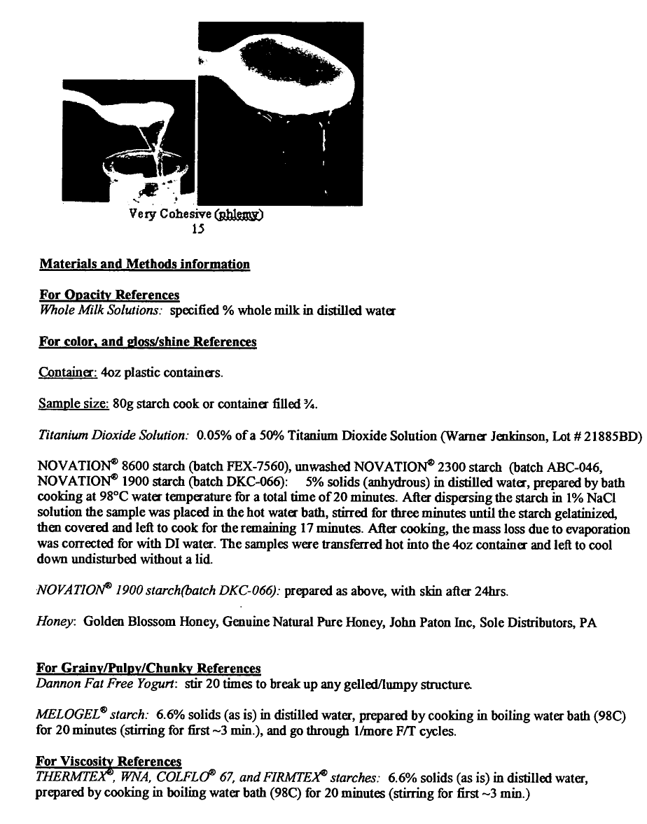

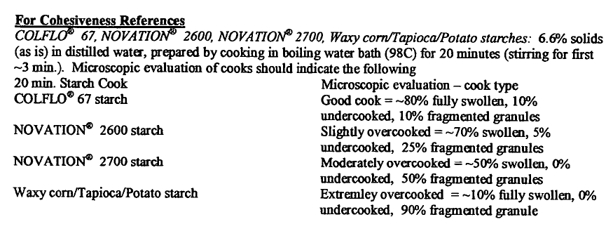

All samples were evaluated for texture based on the ballot set forth in FIG. 3.

G. Brookfield Viscosity

A 4 oz jar was filled with apple baby food. Viscosity was measured at room temperature using a Brookfield DV-II+, “B” t-bar (#92), heliopath OFF, 15 second measurment in centipoise at 10 rpms.

H. Bostwick Consistometer

The Bostwick Consistometer consists of a level, stainless-steel trough with two compartments. The first compartment, which holds the sample to be tested, is separated from the second compartment by a spring-loaded gate. The second compartment is 24 cm long and has graduated, parallel lines at 0.5 cm intervals. The measurement consists of releasing the gate and lefting the fluid flow freely under gravity down the slope. The distance the fluid flows from the gate after 5, 15, 30 and 60 seconds is measured in centimeters as the Bostwick Consistometer reading.

### Example 1

### Heat Moisture Treatment of Waxy, Low Amylose and Regular Rice Flours

This example shows the method for heat moisture treatment of flours.

a. Fine mist of water was sprayed on 1500 g of low amylose rice flour (LARF, amylose content—12%; RM100AR—lot #7519) while mixing it in a Kitchen Aid mixer at number 2-3 speed. Moisture of the flour was checked intermittently during the spraying by the Cenco moisture balance. The flour powder was adjusted to four different final moisture contents of 15, 20, 25, and 30%. It was further mixed for 1 hr to ensure moisture uniformity. About 200 grams of moist flour was then sealed in aluminum cans with less than 1 inch head space. The sealed aluminum cans were placed in ovens already at the desired temperatures of 75° C., 90° C., 95° C., 100° C., and 120° C. for the heat moisture treatment. There was 30 minute ramp up time to allow the sample temperature inside the cans to equilibrate with the outside oven temperature. The sample was further held at that temperature for 2 hours. After the heat-moisture treatment, the cans were opened and the heat moisture treated (HMT) flours were air-dried at room temperature. The dry samples were ground to fine powder using a coffee grinder and sieved using a US mesh 20 screen (0.841 mm sieve opening). Samples were subsequently characterized for thermal and Theological properties.

b. Example 1a was repeated for waxy rice flour except that the moisture was adjusted to 25% and was then heat treated at 95° C.

c. Example 1a was repeated for regular rice flour except that the moisture was adjusted to 20% and was then heat treated at 100° C.

TABLE 1
Thermal analysis of the native and heat moisture treated flours
was performed using DSC. The average values are reported below.

| Sample | | Temp | Moisture | Time | To | Tp | Tc | Delta H |
|---|---|---|---|---|---|---|---|---|
| # | Base Material | (° C.) | (%) | (hr) | (° C.) | (° C.) | (° C.) | (J/g) |
| 1 | Low amylose rice flour | — | — | — | 60.2 | 71 | 81.2 | 13.1 |
| 2 | Low amylose rice flour | 90 | 25 | 2 | 66.7 | 75.1 | 85.2 | 11.7 |
| 3 | Low amylose rice flour | 95 | 20 | 2 | 63.2 | 72 | 83.6 | 12 |
| 4 | Low amylose rice flour | 95 | 25 | 2 | 67.3 | 77.3 | 87.8 | 11.9 |
| 5 | Low amylose rice flour | 100 | 20 | 2 | 65.8 | 74.6 | 85.2 | 12.1 |
| 6 | Low amylose rice flour | 100 | 25 | 2 | 68 | 79 | 88.5 | 10.3 |
| 7 | Low amylose rice flour | 110 | 20 | 2 | 65.2 | 73.8 | 85.5 | 12.5 |
| 8 | Low amylose rice flour | 110 | 25 | 2 | 66.6 | 80.8 | 90.2 | 8.3 |
| 9 | Low amylose rice flour | 120 | 20 | 2 | 65.5 | 75.8 | 87.4 | 11.2 |
| 10 | Low amylose rice flour | 120 | 25 | 2 | 66.3 | 77.8 | 90.1 | 8.1 |
| 11 | Regular amylose rice flour | — | — | — | 71.8 | 78.1 | 87.1 | 20.1 |
| 12 | Regular amylose rice flour | 100 | 25 | 2 | 79.1 | 85.3 | 89.9 | 17.4 |
| 13 | Regular amylose rice flour | 120 | 20 | 2 | 73.9 | 79.6 | 89.3 | 14 |

Heat moisture treated low amylose rice flour showed high viscosity and desired texture in application. As shown in table 1, heat moisture treatment of the amylose-containing flour shows significant changes in the thermal properties. Heat moisture treated low amylose rice and regular rice flours have higher onset and peak melting temperatures than the untreated native flours. Heat moisture treated flours having higher melting temperatures would resist swelling and show delayed gelatinization during cooking. Therefore, inhibition of flours can be achieved via annealing using the heat moisture treatment process. Flours treated at various heat moisture conditions with different thermal properties may provide different degrees of inhibition.

### Example 2

### Physical Properties of Heat-Moisture Treated Flours

### Example 2a

This example illustrates the physical properties of the heat moisture treated rice flours and native rice flours. The data depicted in Table 2A (prepared from cooking method B1) demonstrate that the heat moisture treated low amylose rice flours show higher elastic modulus and lower tangent delta than the untreated native flour. For example, samples 22, 2, 23, and 10 show higher elastic modulus than the untreated native low amylose rice flour. In contrast, waxy rice flour (sample 26) and regular rice flour (sample 27) do not show a significant improvement in elastic modulus or tangent delta over the respective native flours (samples 25, 11).

TABLE 2A
Preparation of heat moisture treated flours, and physical
properties based on cooking procedure B1.

| Sample | | Temp | Moisture | Time | | Tan | |
|---|---|---|---|---|---|---|---|
| # | Base Material | (C.) | (%) | (minutes) | G′(Pa) | delta | Absorbance |
| 1 | Low Amylose Rice | | | | 6.51 | 1.24 | 0.5 |
| 22 | Low Amylose Rice | 90 | 15 | 120 | 14.36 | 0.94 | 0.388 |
| 2 | Low Amylose Rice | 90 | 25 | 120 | 14.56 | 0.94 | 0.384 |
| 23 | Low Amylose Rice | 120 | 15 | 120 | 77.52 | 0.37 | 0.1 |
| 10 | Low Amylose Rice | 120 | 25 | 120 | 62.07 | 0.42 | 0.141 |
| 24 | Low Amylose Rice | 75 | 30 | 120 | 11.12 | 0.96 | 0.549 |
| 25 | Waxy Rice | | | | 3.03 | 1.86 | 0.5 |
| 26 | Waxy Rice | 95 | 25 | 120 | 4.41 | 1.41 | 0.211 |
| 11 | Regular Rice | | | | 277.16 | 0.12 | 0.169 |
| 27 | Regular Rice | 100 | 20 | 120 | 124.5 | 0.21 | 0.212 |

### Example 2b)

It should be noted that numerically identified samples labeled “b” are the same as those without the “b” (e.g. 27 and 27b are the same sample). The “b” simply denotes that the test was done at a separate time.

TABLE 2B
Preparation of heat moisture treated flours, and physical
properties based on cooking procedure B2.

| Sample | | Temp | Moisture | Time | | Tan | |
|---|---|---|---|---|---|---|---|
| # | Base Material | (C.) | (%) | (minutes) | G′(Pa) | delta | Absorbance |
| 1 | Low Amylose Rice | | | | 230.04 | 0.22 | 0.189 |
| 17b | Low Amylose Rice | 100 | 20 | 120 | 350.87 | 0.19 | 0.115 |
| 28 | Low Amylose Rice | 100 | 25 | 120 | 329.83 | 0.19 | 0.133 |
| 11 | Regular Rice | | | | 830.57 | 0.07 | |
| 27b | Regular Rice | 100 | 20 | 120 | 1034.94 | 0.07 | |
| 12b | Regular Rice | 100 | 25 | 120 | 1120.87 | 0.07 | |

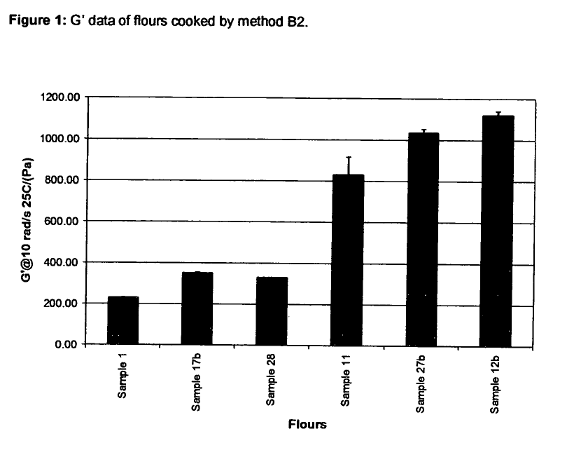

At 12.8% amylose the heat moisture treated flours (sample #17b and #28) had higher stiffness than the control base flours (sample #1). The heat moisture treated regular rice flours (sample #27b and #12b) had significantly higher stiffness than sample 17b and sample 28. These samples (11, 27b, and, 12b) also exhibit a soft gel texture which is quite different from the textures of samples 1, 17b, and 28. This is represented in FIG. 1 and Table 2B.

### Example 3

### Granular Integrity of Heat-Moisture Treated Flours

This example illustrates the increase in granular integrity achieved (as measured by decrease in absorbance) via heat moisture treatment of flour.

Table 2A shows absorbance data for heat moisture treated flours. As shown, the heat moisture treated flours show lower absorbance as compared to the native flours, indicating a higher degree of granular integrity, which contributes to desirable physical properties of the cook. Table 2B shows the data for heat moisture treated flours using cooking procedure B2 as explained above.

Texture Evaluations:

TABLE 3
Texture evaluation of flour using cooking procedure B2 (boiling water bath) study

| Sample | | | | Grainy/ | | | |
|---|---|---|---|---|---|---|---|
| # | Opacity | Color | Gloss/Shine | pulpy/chunky | Grainy | Viscosity | Cohesivenes [symbol] |
| 1 | 10 | 3 | 0 | 1 | 5 | 7 | 4-5 |
| 17 | 15 | 0 | 0 | 1 | 7 | 7 | 0 |
| 28 | 15 | 0 | 0 | 1 | 7 | 7 | 0 |
| 11 | n/a | n/a | n/a | n/a | n/a | soft gel | n/a |
| 27b | n/a | n/a | n/a | n/a | n/a | soft gel | n/a |
| 12b | n/a | n/a | n/a | n/a | n/a | soft gel | n/a |

The texture evaluations in table 3 above supports example 2b above. All food products prepared with regular rice flour samples with an amylose content of 22.7% were gelled (samples 11, 27b and 12b). In contrast, food product prepared with low amylose containing rice flour samples did not gel. It should be noted that, because of the intensity of gel formation observed for flour samples made from regular rice, it was not possible to evaluate the products for the chosen product criteria. This is indicated by “n/a” statements in Table 3.

### Example 4

### Heat Moisture Treatment of Low Amylose Rice Flour at Different Processing Times

This example shows the heat moisture treatment of low amylose rice flours over different periods of time.

45 kg of low amylose rice flour were loaded into a batch process ploughshare mixer and dryer (Model: 300HP Prestovac reactor manufactured by Processall, Cincinnati, Ohio, USA). The reactor can be pressurized to control the moisture in the flour at temperatures above 100° C. The flour was fluidized through the mixing action and water was sprayed onto the flour to achieve a final moisture content of 19.1%. The reactor was pressurized to 40 psi (2.7 bar) and the moisture adjusted flour was heated to a target product temperature of 100° C. The heat-up time was 1 hr. At the target temperature of 100° C., the heat treatment was performed for 120 min and samples were taken at 30, 60, 90 and 120 min. All samples were air dried to 10 to 12% moisture, and sieved through a US 20 mesh screen (0.841 mm sieve opening). The samples of heat-moisture treated low amylose rice flour, identified in Table 4 as samples 14 through 17, were evaluated for rheological properties and absorbance (using test methods B1 and C1). The data in Table 4 show that a processing time of 60 to 120 min produced a low amylose rice flour composition with desirable rheological properties as described by the modulus G′ and tan delta. Further, the data show that a longer processing time produced compositions with more desirable rheological properties.

TABLE 4
Heat moisture treatment of low amylose rice flour over time (30-120 minutes)

| Sample | | Temp | Moisture | Time | | Tan | |
|---|---|---|---|---|---|---|---|
| # | Base Material | (C.) | (%) | (minutes) | G′(Pa) | delta | Absorbance |
| 14 | Low Amylose rice | 100 | 20 | 30 | 22.2 | 0.77 | 0.281 |
| 15 | Low Amylose rice | 100 | 20 | 60 | 26.92 | 0.72 | 0.259 |
| 16 | Low Amylose rice | 100 | 20 | 90 | 28.73 | 0.67 | 0.261 |
| 17 | Low Amylose rice | 100 | 20 | 120 | 49.16 | 0.51 | 0.239 |

### Example 5

### Food Prepared Using Heat-Moisture Treated Flour

This example describes the use of heat moisture treated low amylose rice flour in a thickened applesauce formulation. Both, heat moisture treated rice flour and native rice flour were used to prepare retorted thickened applesauce. Results show the increased process tolerance (increased viscosity) of heat moisture treated low amylose rice flour over the native base.

The food was prepared using the below formula:

| INGREDIENTS | % | G |
|---|---|---|
| Apple solids | 69 | 828 |
| Rice flour | 9 | 108 |
| Citric acid | 0.05 | 0.6 |
| Water | 21.95 | 263.4 |
| Total | 100 | 1200 |

The preparation was done as indicated below:

Water, rice flour, and citric acid were slurried. Apple solids was added. The mixture was heated to 65.6° C. (150° F.) and filled into cans at 60-63° C. (140-145° F.). The cans were retorted in Stock Rotary retort at 115.5° C. (240° F.) for 35 minutes. The thickened apple sauce was evaluated for viscosity differences. The DV-II+ Brookfield was used to measure the viscosity with the following parameters: “B” t-bar (#92), heliopath off, 15 second measurement in centipoise at 10 RPMs. Bostwick Consistometer measurements were also done. Bostwick Consistometer measures the filling flow in centimeters at various times (in seconds). Lower numbers correspond to higher viscosity.

The results of the applesauce evaluations are tabulated below in Table 5.

TABLE 5
Brookfield and Bostwick viscosity data of native and
heat moisture treated low amylose rice flours.

| | Brookfield | Bostwick | | | |
|---|---|---|---|---|---|
| Sample # | Visc (cps) | 5 sec | 15 sec | 30 sec | 60 sec |
| 1 (at time = 0 hrs.) | 15,400 | 7.2 | 9.25 | 10.5 | 12 |
| 1 (at time = 24 hrs.) | 14,200 | 7 | 9.1 | 10.4 | 11.75 |
| 17b (at time = 0 hrs.) | 19,100 | 5.7 | 7.1 | 8.3 | 9.4 |
| 17b (at time = 24 hrs.) | 24,200 | 5 | 6.6 | 7.7 | 8.7 |

The results show that the heat moisture treated low amylose rice flour yields applesauce with higher viscosity after retorting. The heat moisture treated low amylose rice flour has acid and heat stability superior to native rice flour.

### Example 6

### Comparison of Heat Moisture Treated Low Amylose Rice Flour with Heat Moisture Treated Blends of Waxy and Regular Rice Flours

This example shows the physical properties obtained by heat-moisture treated blends of non-amylose containing rice flour (amylose content <3%) and regular-amylose containing rice flours (amylose content of 22%), and compares them to properties of heat-moisture treated low-amylose rice flour. Heat-moisture treated low amylose rice flour, processed at 20% moisture and 100° C., was compared to (50:50 w/w) blends of waxy rice flour and regular rice flour, heat-moisture treated at the same conditions. At this blend ratio, the amylose level, calculated with 12.5%, was comparable to that in the low amylose rice flour (12.8%). Two techniques were used for preparing the samples:
(i) pre-blending the flours followed by heat-moisture treatment (sample 20)
(ii) heat-moisture treating the individual components and then blending together (sample 21)

The samples were characterized using test methods B1 and C1. Data are shown in Table 6. It can be seen that all the blends show lower elastic modulus and higher tangent delta as compared to the heat-moisture treated low amylose rice flour. The regular amylose rice flour showed an undesirable gelled texture, resulting in too high elastic modulus, and too low tangent delta.

TABLE 6
Characterization of rice flour blends

| Sample | | Temp | Moisture | Time | | Tan | |
|---|---|---|---|---|---|---|---|
| # | Description | (C.) | (%) | (minutes) | G′(Pa) | delta | Absorbance |
| 18 | Waxy Rice | 100 | 25 | 120 | 5.25 | 1.29 | 0.203 |
| 12 | Regular Rice | 100 | 25 | 120 | 313.59 | 0.1 | 0.095 |
| 19 | 50:50 waxy:regular | | | | 15.65 | 0.81 | 0.261 |
| 20 | 50:50 waxy:regular (preblended) | 100 | 25 | 120 | 17.36 | 0.79 | 0.213 |
| 21 | 50:50 waxy:regular (post-blended) | 100 | 25 | 120 | 21.61 | 0.68 | 0.209 |
| 6 | Low Amylose Rice | 100 | 25 | 120 | 71.71 | 0.39 | 0.298 |

Note:
Samples analyzed and cooked under method B1 conditions.

### Example 7

### Impact of Heat Moisture Treatment on Inhibition and Process Tolerance of Waxy Rice Flour and Low Amylose Rice Flour

This example shows the impact of heat moisture treatment on the inhibition of low amylose rice flour as measured by the Brabender viscosity under neutral conditions (pH−6.5) and compares it to heat-moisture treated waxy rice flour. It is known in the art that a non-inhibited starch or starch containing composition shows a peak viscosity and a subsequent breakdown in viscosity upon holding the composition at a cook temperature as defined in respective Brabender procedures. In contrast, inhibited process tolerant compositions show no breakdown or a continuous rise in viscosity.

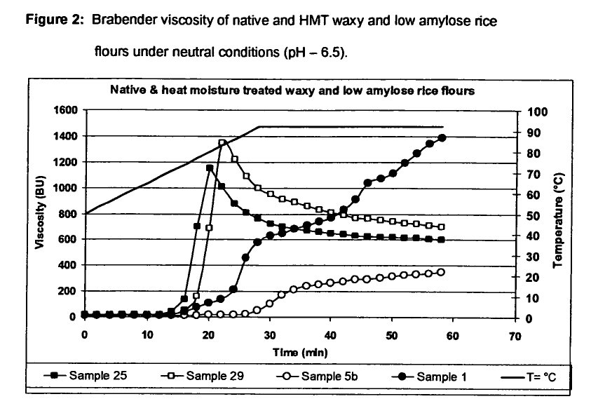

As illustrated in FIG. 2, heat moisture treated Waxy rice flour does not show inhibition as indicated by breakdown in viscosity at the 92° C. hold (sample 29-moisture 20%, 100° C. for 2 hrs hold time). Contrary, heat-moisture treated low amylose rice flour shows a rise in viscosity which is typical for an inhibited composition (sample 5b). Further, the product shows a significantly delayed gelatinization temperature and sustained viscosity at 92° C. By manipulating the heat moisture process, flours inhibited to different degrees would provide process tolerance in food applications.

We claim:

1. A flour characterized by
a. a modulus of greater than 25 and less than 150;
b. a tangent delta of greater than 0.25 and less than 1.0; and
c. solution stability,
wherein the flour is a rice flour and the modulus and tangent delta are measured using Rheology Method B1.

2. The flour of claim 1, further characterized by enhanced process tolerance.

3. The flour of claim 1, further comprising a low amylose content.

4. The flour of claim 1, wherein the flour has an amylose content of from 5 to 15% by weight of starch in the flour.

5. The flour of claim 4, wherein the amylose content is from 10 to 13% by weight of starch in the flour.

6. The flour of claim 1, further characterized by an absorbance value of at least 0.1 and less than 0.3 using Absorbance Method C1.

7. The flour of claim 1, wherein the flour is substantially chemically unmodified.

8. A composition comprising the flour of claim 1 and at least one other edible component.

9. A composition comprising the flour of claim 5 and at least one other edible component.

10. A process of heat-treating flour comprising:
a) heating a rice flour under the conditions of a moisture content of between from 10 to 80% by weight of the dry flour, at a target temperature of from 50 to 180° C., and a time of 1 to 150 minutes at the target temperature to form a heat-treated flour;
wherein the conditions are chosen so that the starch in the flour retains its granular structure;
wherein the heat-treated flour is characterized by a modulus of greater than 25 and less than 150; a tangent delta of greater than 0.25 and less than 1.0; and solution stability; and
wherein the modulus and tangent delta are measured using Rheology Method B1.

11. The process of claim 10, wherein the heat-treated flour is further characterized by enhanced process tolerance.

12. The process of claim 10, wherein the flour is a low amylose flour.

13. The process of claim 10, wherein the flour has an amylose content of from 5 to 15% by weight of starch in the flour.

14. The process of claim 10, wherein the flour has an amylose content of from 10 to 13% by weight of starch in the flour.

15. The process of claim 10, wherein the moisture of the flour is between 15 and 30% by weight of the dry flour.

16. The process of claim 10, wherein the target temperature is between 80 and 120° C.

17. The process of claim 10, wherein the time at target temperature is between 30 and 120 minutes.

18. The process of claim 10, wherein the moisture is kept substantially constant during heating.

19. A non-gelling amylose-containing rice flour characterized by:
(a) an absorbance value of less than 0.2 and greater than 0.1 by Absorbance Method C2;
(b) a G′of greater than 250 Pa and less than 600 Pa; and
(c) a tan delta of greater than 0.10 and less than 0.50;
wherein the modulus and tangent delta are measured using Rheology Method B2.

20. The flour of claim 19, further characterized by enhanced process tolerance.

21. The flour of claim 19, further comprising a low amylose content.

22. The flour of claim 19, wherein the flour is a rice flour with an amylose content of from 5 to 15% by weight of starch in the flour.

23. The flour of claim 22, wherein the amylose content is from 13 to 15% by weight of starch in the flour.

24. The flour of claim 19, wherein the flour is substantially chemically unmodified.

25. A composition comprising the flour of claim 19 and at least one other edible component.

26. A process of heat-treating flour comprising:
heating a rice flour under the conditions of a moisture content of between from 10 to 80% by weight of the dry flour, at a target temperature of from 50 to 180° C., and a time of 1 to 150 minutes at the target temperature to form a heat-treated flour;
wherein the conditions are chosen so that the starch in the flour retains its granular structure;
wherein the heat-treated flour is characterized by an absorbance value of less than 0.2 and greater than 0.1 by Absorbance Method C2, a G′ of greater than 250 Pa and less than 600 Pa, and a tan delta of greater than 0.10 and less than 0.50; wherein the modulus and tangent delta are measured using Rheology Method B2.

27. The process of claim 26, wherein the heat-treated flour is further characterized by enhanced process tolerance.

28. The process of claim 26, wherein the flour is a low amylose flour.

29. The process of claim 26, wherein the flour has an amylose content of from 5 to 15% by weight of starch in the flour.

30. The process of claim 26, wherein the flour has an amylose content of from 13 to 15% by weight of starch in the flour.

31. The process of claim 26, wherein the moisture of the flour is between 15 and 30% by weight of the dry flour.

32. The process of claim 26, wherein the target temperature is between 80 and 120° C.

33. The process of claim 26, wherein the time at target temperature is between 30 and 120 minutes.

34. The process of claim 26, wherein the moisture is kept substantially constant during heating.
